(19) United States
(12) Patent Application Publication
(10) Pub. No.: US 2026/0093506 A1
(43) Pub. Date: Apr. 2, 2026

(54) CLOUD DESKTOP SYSTEM, CLOUD DESKTOP DISPLAY METHOD, TERMINAL DEVICE AND STORAGE MEDIUM

(71) Applicant: CLOUD INTELLIGENCE ASSETS HOLDING (SINGAPORE) PRIVATE LIMITED, Singapore (SG)

(72) Inventors: Kui LUO, Hangzhou, Zhejiang (CN); Jia RONG, Hangzhou, Zhejiang (CN); Jin LI, Hangzhou, Zhejiang (CN); Chao XIA, Hangzhou, Zhejiang (CN); Zhongshen WU, Hangzhou, Zhejiang (CN)

(21) Appl. No.: 19/113,395

(22) PCT Filed: Sep. 18, 2023
(86) PCT No.: PCT/CN2023/119539

§ 371 Date: Mar. 19, 2025

(30) Foreign Application Priority Data
Sep. 19, 2022 (CN) 202211139002.X

(51) Int. Cl. G06F 9/451; G06T 1/20

(52) U.S. Cl. CPC G06F 9/452; G06T 1/20

(57) ABSTRACT

Embodiments of the present application provide a cloud desktop system, a cloud desktop display method, a terminal device and a storage medium. In an embodiment of the present application, plane data required by a cloud desktop is divided into two parts, one part is provided by a cloud side server, and the other part is provided locally by a terminal. Further, combined with the advantages that the terminal supports a primary plane and an overlay plane, the terminal only needs to decode the plane data provided by the cloud side server and send and display it directly to the overlay plane, which omits a link of rendering this part of plane data through a GPU, and reduces the delay overheads of communication between different processes caused by the GPU rendering link; and in further, the time-consuming overheads caused by GPU rendering can be reduced, reducing the display delay of the cloud desktop, and improving the display efficiency. In addition, only the part of plane data provided locally is rendered using the GPU, and the plane data provided by the cloud side server is no longer rendered using the GPU, which can also reduce the power consumption of the terminal, thereby reducing the temperature rise of the terminal device.

### CROSS-REFERENCE TO RELATED APPLICATIONS

The present disclosure is a National Stage of International Application No. PCT/CN2023/119539, filed on Sep. 18, 2023, which claims the priority to Chinese Patent Application No. 202211139002.X filed to China National Intellectual Property Administration on Sep. 19, 2022 and titled “Cloud Desktop System, Cloud Desktop Display Method, Terminal device and Storage Medium”, the entire contents of these applications are incorporated herein by reference.

### TECHNICAL FIELD

The present disclosure relates to the field of cloud computing technology and, in particular to a cloud desktop system, a cloud desktop display method, a terminal device and a storage medium.

### TECHNICAL BACKGROUND

A cloud desktop, also known as desktop virtualization and a cloud computer, is a new model to replace a traditional computer. The cloud desktop has logic that data and computation of a traditional computer desktop are mainly carried out on a cloud side server. After adopting the cloud desktop, a user doesn't need to buy a computer host, and all components such as a CPU, a memory and a hard disk required by the host are virtually obtained by the cloud side server. The user can use his/her own cloud desktop through a personal computer, a thin client and other terminals to achieve the same experience as the traditional computer.

In a cloud desktop system, a cloud desktop client is installed on a local terminal, which interacts with a cloud side server through a specific communication protocol to acquire cloud desktop data provided by the cloud side server, and then renders the cloud desktop data with the help of the graphics rendering capability of a GPU, and displays a rendered cloud desktop. The cloud desktop is finally displayed on the terminal side. The smaller the display delay, the better the user experience. Therefore, it is necessary to optimize an existing rendering process of the cloud desktop to reduce the display delay of the cloud desktop and improve the user experience.

### SUMMARY

Various aspects of the present disclosure provide a cloud desktop system, a cloud desktop display method, a terminal device and a storage medium, which are configured for optimizing the rendering process of the cloud desktop, reducing the display delay of the cloud desktop and improving the user experience.

An embodiment of the present disclosure provides a cloud desktop system, which includes a cloud side server configured to provide a first part of plane data required by a cloud desktop, and a terminal device configured to provide a second part of plane data required by the cloud desktop and present the cloud desktop, where the terminal device at least includes a plurality of hardware planes, and the plurality of hardware planes include a primary plane and at least one overlay plane; the cloud side server is configured to transmit the first part of plane data to the terminal device according to a dynamic display requirement of the cloud desktop; the terminal device is configured to decode the first part of plane data transmitted by the cloud side server to obtain first intermediate plane data, send and display the first intermediate plane data to a first overlay plane in the at least one overlay plane, and load the second part of plane data, call a graphic processing unit GPU to render the second part of plane data to obtain second intermediate plane data, send and display the second intermediate plane data to the primary plane; perform a hardware synthesis on the first intermediate plane data and the second intermediate plane data to obtain first plane data to be displayed, and display the first plane data to be displayed to obtain the cloud desktop.

An embodiment of the present disclosure also provides a terminal device, which is configured to provide a second part of plane data required by a cloud desktop and present the cloud desktop, where the terminal device includes a computing processor, a memory, a graphic processing unit GPU, a plurality of hardware planes and a display controller, where the plurality of hardware planes include a primary plane and at least one overlay plane; the memory is configured to store a computer program corresponding to a cloud desktop client, and the computing processor is coupled with the memory and configured to execute the computer program, to: receive a first part of plane data required by the cloud desktop and transmitted by a cloud side server according to a dynamic display requirement of the cloud desktop; decode the first part of plane data to obtain first intermediate plane data; send and display the first intermediate plane data to a first overlay plane in the at least one overlay plane; and load the second part of plane data, call the GPU to render the second part of plane data to obtain second intermediate plane data, send and display the second intermediate plane data to the primary plane; the display controller is configured to perform a hardware synthesis on the first intermediate plane data in the first overlay plane and the second intermediate plane data in the primary plane to obtain first plane data to be displayed, and display the first plane data to be displayed to obtain the cloud desktop.

An embodiment of the present disclosure also provides a cloud desktop display method applied to a terminal device, where the terminal device is configured to provide a second part of plane data required by a cloud desktop and present the cloud desktop, the method includes: receiving a first part of plane data required by the cloud desktop and transmitted by a cloud side server according to a dynamic display requirement of the cloud desktop; decoding the first part of plane data to obtain first intermediate plane data, sending and displaying the first intermediate plane data to a first overlay plane in at least one overlay plane contained in the terminal device; loading the second part of plane data, calling a GPU to render the second part of plane data to obtain second intermediate plane data, sending and displaying the second intermediate plane data to a primary plane contained in the terminal device; performing a hardware synthesis on the first intermediate plane data and the second intermediate plane data to obtain first plane data to be displayed, and displaying the first plane data to be displayed to obtain the cloud desktop.

An embodiment of the present disclosure also provides a cloud desktop display apparatus applied to a terminal device, where the terminal device is configured to provide a second part of plane data required by a cloud desktop and present the cloud desktop, and the apparatus includes a receiving module configured to receive a first part of plane data required by the cloud desktop and transmitted by a cloud side server according to a dynamic display requirement of the cloud desktop; a decoding module configured to decode the first part of plane data to obtain first intermediate plane data; a first sending and displaying module configured to send and display the first intermediate plane data to a first overlay plane in at least one overlay plane contained by the terminal device; a loading module configured to load the second part of plane data; a rendering module configured to call a GPU to render the second part of plane data to obtain second intermediate plane data; a second sending and displaying module configured to send and display the second intermediate plane data to a primary plane contained by the terminal device; a displaying control module configured to perform a hardware synthesis on the first intermediate plane data and the second intermediate plane data to obtain first plane data to be displayed, and display the first plane data to be displayed to obtain the cloud desktop.

An embodiment of the present disclosure also provides a computer-readable storage medium storing a computer program, where the computer program, when executed by a processor, enables the processor to implement steps in the cloud desktop display method provided by the embodiments of the present disclosure.

In an embodiment of the present disclosure, plane data required by a cloud desktop is divided into two parts, one part is provided by a cloud side server, and the other part is provided locally by a terminal. Further, combined with the advantages that the terminal supports a primary plane and an overlay plane, the terminal only needs to decode the plane data provided by the cloud side server and send and display it directly to the overlay plane, which omits a link of rendering this part of plane data through a GPU, and reduces the delay overheads of communication between different processes caused by the GPU rendering link; and in further, the time-consuming overheads caused by GPU rendering can be reduced, reducing the display delay of the cloud desktop, and improving the display efficiency. In addition, only the part of plane data provided locally is rendered using the GPU, and the plane data provided by the cloud side server is no longer rendered using the GPU, which can also reduce the power consumption of the terminal, thereby reducing the temperature rise of the terminal device.

### BRIEF DESCRIPTION OF DRAWINGS

The accompanying drawings described herein are provided to provide a further understanding of the present disclosure and constitute a part of the present disclosure. The illustrative embodiments of the present disclosure and their descriptions are used to explain the present disclosure and do not constitute undue limitations on the present disclosure. In the attached drawings:

FIG. 1 is a schematic structural diagram of a cloud desktop system provided by an embodiment of the present disclosure;

FIG. 2 is a schematic structural diagram of a terminal device provided by an embodiment of the present disclosure;

FIG. 3a is a schematic diagram of a software framework for cloud desktop displaying by a terminal device provided by an embodiment of the present disclosure;

FIG. 3b is a schematic diagram of another software framework for cloud desktop displaying by a terminal device provided by an embodiment of the present disclosure;

FIG. 4a is a schematic diagram of a further software framework for cloud desktop displaying by a terminal device provided by an embodiment of the present disclosure;

FIG. 4b is a schematic diagram of a further software framework for cloud desktop displaying by a terminal device provided by an embodiment of the present disclosure;

FIG. 5a is a flow diagram of a cloud desktop display method provided by an embodiment of the present disclosure;

FIG. 5b is a flow diagram of another cloud desktop display method provided by an embodiment of the present disclosure; and

FIG. 6 is a schematic structural diagram of a cloud desktop display apparatus provided by an embodiment of the present disclosure.

### DESCRIPTION OF EMBODIMENTS

In order to make the purpose, technical solution and advantage of the present disclosure clearer, the technical solutions of the present disclosure will be described clearly and completely in combination with specific embodiments and the corresponding accompanying drawings of the present disclosure. It is evident that the described embodiments are only a part of the embodiments of the present disclosure, but not all of the embodiments. Based on the embodiments in the present disclosure, all other embodiments obtained by those of ordinary skill in the art without creative work fall into the protection scope of the present disclosure.

For the existing technical problem in connection with the delay, in some embodiments of the present disclosure, plane data required by a cloud desktop is divided into two parts, one part is provided by a cloud side server and the other part is provided locally by a terminal. Further, combined with the advantages that the terminal supports a primary plane and an overlay plane, the terminal only needs to decode the plane data provided by the cloud side server and send and display it directly to the overlay plane, which omits a link of rendering this part of plane data through a GPU, and reduces the delay overheads of communication between different processes caused by the GPU rendering link; and in further the time-consuming overheads caused by GPU rendering can be reduced, reducing the display delay of the cloud desktop, and improving the display efficiency. In addition, only the part of plane data provided locally is rendered using the GPU, and the plane data provided by the cloud side server is no longer rendered using the GPU, which can also reduce the power consumption of the terminal, thereby reducing the temperature rise of the terminal device.

In the following, the technical solution provided by each embodiment of the present disclosure will be described in detail with the attached drawings.

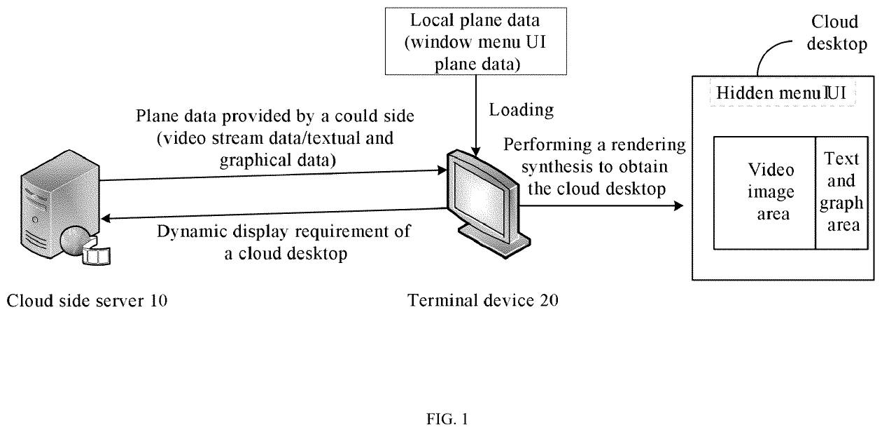

FIG. 1 is a schematic structural diagram of a cloud desktop system provided by an embodiment of the present disclosure. As shown in FIG. 1, the system 100 includes a cloud side server 10 and a terminal device 20. The communication connection between the cloud side server 10 and the terminal device 20 can be wired connection or wireless connection, and the wireless connection includes but not is limited to a wireless connection based on a mobile communication network, WiFi, Bluetooth, infrared, etc. The mobile communication network is not limited in the embodiment in terms of its standard, and can be, for example, a 4G network, a 5G network, a 6G network, and a network of other standard that may appear in the future.

In the embodiment, the terminal device is not limited in terms of its implementation form, which can be various terminal devices with a displayer and communication ability and certain computing ability, such as a notebook computer, a desktop computer, a tablet computer, a smart phone, a wearable device and the like. Similarly, the cloud side server is not limited in the embodiment of the present disclosure in terms of its implementation form, which can be a traditional cloud side server, or a variety of cloud products such as a server cluster, a virtual machine and a container deployed in the cloud.

In the embodiment, the cloud side server and the terminal device cooperate with each other to implement the cloud desktop system. In the embodiment, the cloud desktop system can provide a cloud desktop, and the cloud desktop in the embodiment needs two parts of plane data, namely a first part of plane data and a second part of plane data. The first part of plane data is provided by the cloud side server, and the second part of plane data is provided locally by the terminal device. In addition to providing the second part of plane data required by the cloud desktop, the terminal device is configured to acquire the first part of plane data provided by the cloud side server, and present the cloud desktop locally according to the first part of plane data and the second part of plane data. The first part of plane data and the second part of plane data are different plane data. In addition, the terminal device 20 in the embodiment at least includes a plurality of hardware planes, which include a primary plane and at least one overlay plane. The primary plane and the at least one overlay plane in the embodiment belong to hardware plane modules and belong to a hardware level. In the embodiment, the primary plane usually supports a simple plane in an RGB format, and the overlay plane usually supports a plane in one or more formats, such as but not limited to a plane in a YUV format.

In the embodiment, the cloud side server 10 is mainly responsible for the computation related to the cloud desktop system, such as the storage, rendering, streaming and other processing of the first part of plane data, and is also configured to acquire a dynamic display requirement of the cloud desktop and transmit the first part of plane data to the terminal device 20 according to the dynamic display requirement of the cloud desktop. The first part of plane data can be some plane data which is required by the cloud desktop and whose content changes frequently, such as video stream data played in the cloud desktop, and/or some interactive textual and graphical data, textual and graphical data with a high update frequency or textual and graphical data prone to changes in the cloud desktop. The cloud side server 10 is responsible for processing these frequently changing plane data, which can make full use of the advantages of rich and flexible cloud side resources and reduce the resource consumption and processing burden of the terminal device 20. Accordingly, the second part of plane data can be some plane data required by the cloud desktop with a low frequency of content change or basically unchanged content, such as UI plane data of a hidden menu required by the cloud desktop, or some plane data with a small data volume, or the like. These plane data are simple to process and consume fewer terminal resources, and can be processed on the terminal side, which can reduce the consumption of bandwidth resources of the terminal device.

In some application scenarios, a video image will be played in the cloud desktop, for example, an icon of respective application software is displayed in the cloud desktop, and the user chooses to open video playing software, at this time, a video image will be played on the cloud desktop. In the case of playing a video image in the cloud desktop, the dynamic display requirement of the cloud desktop is related to the playing progress of the video image played in the cloud desktop, and the display requirement of the cloud desktop will change dynamically with the change of the playing progress of the video image. The cloud side server 10 can monitor the playing progress of the video image in the cloud desktop, and determine the dynamic display requirement of the cloud desktop according to the playing progress of the video image, and the dynamic display requirement can reflect the video image content that the cloud desktop needs to present at present, and the video image content is an example of the first part of plane data provided by the cloud side server 10.

In other application scenarios, in addition to playing a video image, the cloud desktop window can also present some pages, such as web pages, and some interactive controls are included on these pages, such as a Like control, a Follow control, a Favorite control, a Comment control, a Refresh control and some link controls directing to other pages. The user can interact with the cloud desktop through these controls. In the case that the cloud desktop supports a user interaction, when the terminal device 20 presents the cloud desktop, the terminal device 20 can also respond to an interactive operation initiated by the user through the cloud desktop (e.g., an interactive control on the cloud desktop), for example, an interactive operation of refreshing a page, sharing a page, bookmarking a page, or liking, following, commenting, etc., and transmit a data acquisition request of the cloud desktop to the cloud side server 10, where the data acquisition request reflects the content that the cloud desktop currently needs to display. According to the data acquisition request, the cloud side server 10 can determine the dynamic display requirement of the cloud desktop, and then according to the dynamic display requirement, return the latest textual and graphical data (including a picture, a text or new page data, etc.) required by the cloud desktop to the terminal device 20. These textual and graphical data are examples of the first part of plane data provided by the cloud side server 10.

Of course, in further application scenarios, the cloud desktop can play a video image and present related textual and graphical data at the same time. For example, the cloud desktop can be implemented as a video playing interface (such as a web page), which includes a video playing area and a text and graph presenting area. While watching a video image, the user can initiate an interactive operation related to the video image, for example, controlling the playing progress of the video image, changing the series of the video image, making comments, displaying bullet comments, and so on.

When the cloud side server 10 transmits the first part of plane data, the terminal device 20 can receive the first part of plane data transmitted by the cloud side server 10, decode the first part of plane data transmitted by the cloud side server 10 to obtain first intermediate plane data, send and display the first intermediate plane data to a first overlay plane in at least one overlay plane. In the embodiment, the decoding method of the first part of plane data is not limited, but depends on the encoding method adopted by the cloud side server 10, such as H264, H265, JPEG, MPEG and so on. It should be noted that the presentation of the cloud desktop window by the terminal device 20 depends on all the plane data required by the cloud desktop window, so the terminal device 20 also loads the second part of plane data; calls a graphic processing unit (GPU) to render the second part of plane data to obtain second intermediate plane data; sends and displays the second intermediate plane data to the primary plane; and finally performs a hardware synthesis on the first intermediate plane data and the second intermediate plane data to obtain first plane data to be displayed, and displays the first plane data to be displayed to obtain the cloud desktop. Displaying the first plane data to be displayed refers to the process of transmitting the first plane data to be displayed to the displayer of the terminal device for display.

To describe here, the first plane data to be displayed is plane data synthesized from the first intermediate plane data and the second intermediate plane data, and the “first” is added for the convenience of distinguishing it from other synthesized plane data, and the “first” here doesn't mean a limitation on the number and sequence. Similarly, the words “first” and “second” in front of intermediate plane data are also used to distinguish different intermediate plane data, and also don't mean limitations on the number and sequence. The order of obtaining the first intermediate plane data and the second intermediate plane data is not limited, and the two steps can be executed in any sequential order or in parallel.

In the embodiment, the terminal device only needs to decode the first part of plane data provided by the cloud side server, send and display it to the first overlay plane without GPU rendering, thus omitting the link of rendering this part of plane data through a GPU, reducing the delay overheads of communication between different processes caused by the GPU rendering link; and in further, the time-consuming overheads caused by the GPU rendering can be reduced, reducing the display delay of the cloud desktop and improving the display efficiency. In addition, in the embodiment, only the second part of plane data provided locally is rendered using the GPU, and the plane data provided by the cloud side server is not rendered using the GPU, which can also reduce the power consumption of the terminal, thereby reducing the temperature rise of the terminal device.

Of course, the reason why the GPU rendering link for the first part of plane data is omitted is that the terminal device adopts multiple hardware planes. With the advantage that the terminal device supports an overlay plane, the two parts of plane data are performed with a hardware synthesis through two hardware planes, and the two parts of plane data are no longer performed with a rendering synthesis with use of the GPU, which is beneficial to reducing the delay, saving GPU resources and reducing power consumption.

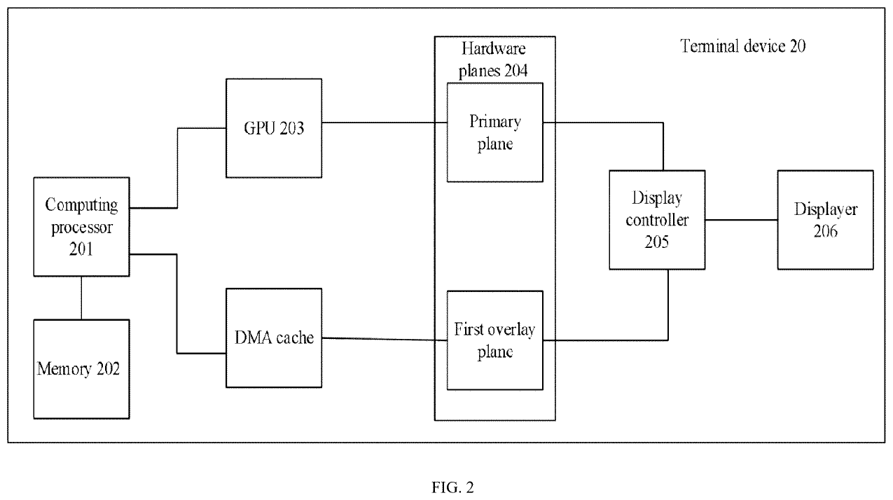

In an embodiment of the present disclosure, as shown in FIG. 2, the terminal device 20 includes but is not limited to the following components: a computing processor 201, a memory 202, a graphic processing unit GPU 203, a plurality of hardware planes 204, a display controller 205 and a displayer 206, where the plurality of hardware planes include a primary plane and at least one overlay plane. The computing processor 201 may be a CPU. The display controller 205 is a hardware module. In an alternative embodiment, the computing processor 201, the memory 202, the graphic processing unit GPU 203, the plurality of hardware planes 204 and the display controller 205, etc. can be implemented as being integrated on one hardware chip, or being distributed on different hardware chips, but they can communicate with each other. In conjunction with the implementation structure of the terminal device 20, description will be made hereunder to a process where the terminal device 20 cooperates with the cloud side server 10 to present the cloud desktop.

A cloud desktop client is installed on the terminal device 20, and an interaction with the cloud side server 10 is possible by running the cloud desktop client, where the cloud desktop client and the cloud side server can interact through a cloud desktop transfer protocol. The cloud desktop transfer protocol is not limited in the embodiment of the present disclosure, which, for example, can be some common cloud transfer protocols or a self-defined transfer protocol. In an implementation, the cloud desktop client can communicate with the cloud side server 10 by adopting, but not limited to, the adaptive stream protocol (ASP), to acquire a first part of plane data provided by the cloud side server 10 and complete the presentation of the cloud desktop according to the first part of plane data and a second part of plane data. Specifically, a computer program corresponding to the cloud desktop client is stored in the memory 202, and the computing processor 201 is coupled with the memory 202 for executing the computer program corresponding to the cloud desktop client, to: receive the first part of plane data required by the cloud desktop which is transmitted by the cloud side server 10 according to the dynamic display requirement of the cloud desktop; decode the first part of plane data to obtain first intermediate plane data, send and display the first intermediate plane data to a first overlay plane in the at least one overlay plane; load the second part of plane data into a CPU cache, call a GPU to render the second part of plane data to obtain second intermediate plane data, send and display the second intermediate plane data to the primary plane.

The display controller 205 is configured to acquire the first intermediate plane data from the first overlay plane and the second intermediate plane data from the primary plane, and then perform a hardware synthesis on the first intermediate plane data and the second intermediate plane data to obtain first plane data to be displayed, and display the first plane data to be displayed to obtain the cloud desktop. Displaying the first plane data to be displayed refers to the process of transmitting the first plane data to be displayed to the displayer 206 of the terminal device for display.

In an alternative embodiment, the plane data required by the cloud desktop includes multiple types, such as three or more. The first part of plane data includes at least two types of plane data, and the second part of plane data includes at least one type of plane data. In order to facilitate the distinction and description, the plane data in the first part of plane data is called cloud side plane data, and the plane data in the second part of plane data is called local plane data. There are at least two types of cloud side plane data and at least one type of local plane data. For different types of cloud side plane data, the cloud side server 10 will only provide one type of cloud side plane data to the terminal device 20 at a time. For the cloud side server 10, according to the dynamic display requirement of the cloud desktop, target cloud side plane data currently adapted to the dynamic display requirement can be determined from the at least two types of cloud side plane data per time, and the target cloud side plane data can be transmitted to the terminal device, and the target cloud side plane data is one of the at least two types of cloud side plane data.

Accordingly, the computing processor 201 is specifically configured to receive, per time, the target cloud side plane data adapted to the dynamic display requirement and transmitted by the cloud side server 10; decode the target cloud side plane data to obtain the first intermediate plane data, send and display the first intermediate plane data to the first overlay plane. In the case that the first part of plane data includes at least two types of cloud side plane data, the first overlay plane is an overlay plane that simultaneously supports the at least two types of cloud side plane data in the at least one overlay plane. That is to say, the at least two types of cloud side plane data can temporally share the same overlay plane, and the overlay plane simultaneously supports at least two types of data formats. In addition, in the case that the second part of plane data includes at least one type of local plane data, the computing processor 201 is specifically configured to simultaneously load the at least one type of local plane data, call a GPU to simultaneously render the at least one type of local plane data to obtain second intermediate plane data, send and display the second intermediate plane data to the primary plane.

In a cloud desktop application scenario, the cloud desktop includes three types of plane data, which are recorded as first initial plane data, third initial plane data and fourth initial plane data. The initial plane data is relative to the intermediate plane data and the plane data to be displayed, and is also a type of plane data in essence. The words “first”, “third” and “fourth” here are also for the convenience of distinction, and don't mean limitations on the number and sequence. The first initial plane data belongs to the local plane data, which refers to window menu content data required by the cloud desktop, and can be simply called hidden menu UI plane data. The third initial plane data belongs to the cloud side plane data, which refers to video stream data required by the cloud desktop. The fourth initial plane data belongs to the cloud side plane data, which refers to textual and graphical data required by the cloud desktop.

The first initial plane data, i.e., the hidden menu UI plane data, is drawn locally by the terminal device through a graphics library, and various graphics libraries are suitable for the embodiments of the present disclosure. For example, QT is an alternative graphics library, and QT is a cross-platform C++ graphical user interface application framework, which provides various functions and application programming interfaces (APIs) required by application developers to establish a state-of-the-art graphical user interface. The third initial plane data, i.e., the video stream data, is a type of data used when playing a video through the cloud desktop, and the format of which can be but not limited to YUV420; YUV420 is a graphic pixel format, which can be simply referred to as Stream plane data; and this plane data is issued by the cloud side server 10. The fourth initial plane data, i.e., the textual and graphical data, carries the data where some text areas or picture areas have changed in the cloud desktop when, for example, browsing a web page. In an implementation, the format of the textual and graphical data can be but not limited to QXL, which is a graphics transmission format and can be simply referred to as QXL plane data; and this plane data is issued by the cloud side server 10 and will be displayed in a BGRA format after being transmitted to the terminal device. The video stream data is usually full-screen data. Of course, the full-screen data can contain only the video stream data, or both the video stream data and the textual and graphical data. The textual and graphical data can be full-screen data, regional stream data or command stream data. The full-screen data refers to data corresponding to the whole hardware plane, and the regional stream data or the command stream data refers to data corresponding to some areas in the hardware plane.

For the sequence of planes, the hidden menu UI plane data of the cloud desktop is placed at the topmost of the cloud desktop, while the video stream data (i.e., Stream plane data) is in the middle and the textual and graphical data (i.e., QXL plane data) is at the bottommost. For a user, among the three kinds of plane data contained in the cloud desktop, the changes of the video stream data and the textual and graphical data are the most somatosensory, so they need to be presented to the displayer with as little time delay as possible.

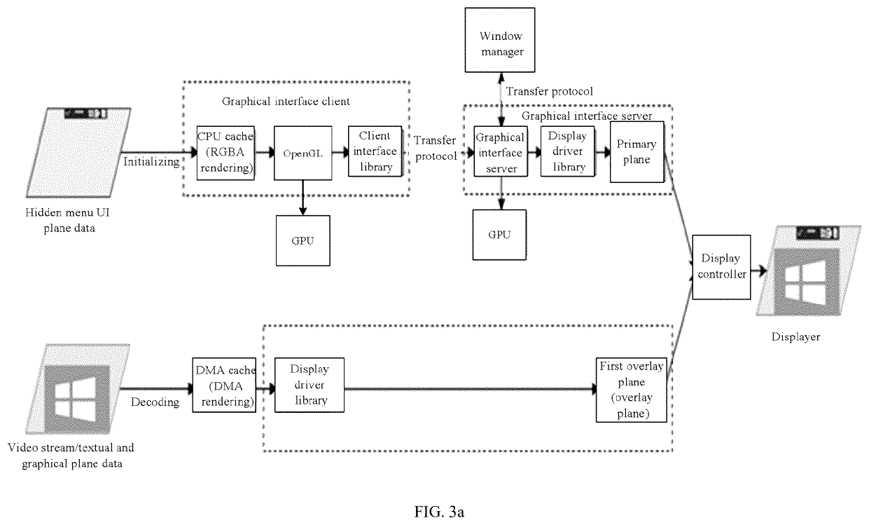

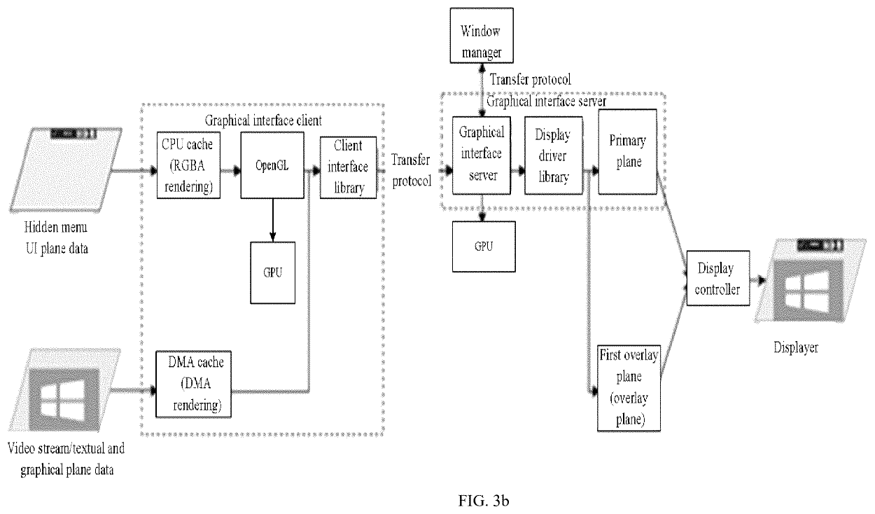

In view of the above scenario, FIG. 3a shows a software framework for a terminal device to display a cloud desktop. In this software framework, on the one hand, the computing processor 201 receives the third initial plane data (i.e., video stream data) or the fourth initial plane data (i.e., textual and graphical data) issued by the cloud side server 10, decodes the third initial plane data (i.e., video stream data) or the fourth initial plane data (i.e., textual and graphical data) to obtain the first intermediate plane data, and directly writes the first intermediate plane data into a direct memory access (DMA) cache without GPU rendering, and provides the first intermediate plane data to the first overlay plane through DMA. The process of providing the first intermediate plane data to the first overlay plane through the DMA includes transmitting the cache ID of the first intermediate plane data in the DMA cache to the first overlay plane by calling the display driver interface of the first overlay plane, where the first overlay plane reads the first intermediate plane data from the DMA cache according to the cache ID, and the cache ID indicates the storage location of the first intermediate plane data in the DMA cache. In the software framework shown in FIG. 3a, the computing processor 201 directly calls, at the layer of the cloud desktop client, the display driver interface provided by the operating system to set the first overlay plane.

It should be noted that the display driver interface of each overlay plane can be provided by the display driver framework in the operating system. The display driver framework will vary with different operating systems used by the terminal device. In the embodiment, in an example of the operating system, such as Linux, a direct rendering manager (DRM) is the display driver framework of the Linux kernel layer, which encapsulates the display function into standard interfaces such as open/close/ioctl, and a user-space program (such as cloud desktop client) call the interfaces to drive a display-related device (such as overlay plane or primary plane) to display data. The standard interfaces provided by the DRM are encapsulated into a display driver library, such as a libdrm library, so that a user can control the display more conveniently. In the software framework shown in FIG. 3a, the first intermediate plane data is sent and displayed to the first overlay plane by calling a display driver interface in the display driver library, such as the libdrm library.

On the other hand, as shown in FIG. 3a, the computing processor 201 is also configured to: load the first initial plane data (i.e., hidden menu UI plane data), initialize a rendering state of the first initial plane data, and encapsulate the first initial plane data and the rendering state thereof into a first data packet; then, call the GPU to render the first data packet to obtain third intermediate plane data; further, call the GPU to perform a rendering synthesis on second initial plane data provided by a window manager and the third intermediate plane data to obtain the second intermediate plane data, where the second initial plane data refers to window menu style data required by the cloud desktop. The rendering state includes a physical texture, a material property and a shader compiled into binary files. Along with the rendering state, lighting and camera related information is also transmitted to the GPU.

It should be noted that the specific implementation process of obtaining the second intermediate plane data through the rendering will also vary with different operating systems used by the terminal device. In some operating system architectures, such as Linux, Ubuntu, Kubuntu, etc., when the operating system needs to provide an interface, the operating system will establish one or several graphical interface servers (for example, X-Server/Wayland in the Linux system), and interact with the window manager through a window transfer protocol (for example, X-Protocol/Wayland Protocol in the Linux system), and interactive interfaces, such as a window, a status bar and a button are generated by an application program independent of the operating system. The application program is referred to as a graphical interface client (for example, X-Client in the Linux system), which is an application program for displaying a graphic on the terminal device, and refers to a cloud desktop client in the embodiment of the present disclosure.

As shown in FIG. 3a, in the architecture of the graphical interface client and the graphical interface server, the graphical interface client is responsible for initializing a rendering state of the first initial plane data and encapsulating the first initial plane data and the rendering state thereof into a first data packet; then, calling a GPU through OpenGL to render the first data packet to obtain third intermediate plane data, and then calling an interface function in a client interface library to transmit the third intermediate plane data to the graphical interface server. OpenGL is a set of API specifications for calling GPU functions, which defines APIs for a series of functions for operating graphics and pictures, and the GPU can be called through the APIs defined by the specifications. Taking the Linux system as an example, the client interface library is Xlib, which is an interface library for the graphical interface client under the X window system protocol written in C language, and which contains a function for communications with the graphical interface server (such as X-Server/Wayland in the Linux system). Further, as shown in FIG. 3a, the graphical interface server is responsible for acquiring the second initial plane data provided by the window manager, calling the GPU to perform a rendering synthesis on the second initial plane data provided by the window manager and the third intermediate plane data to obtain the second intermediate plane data, and then calling the display driver interface provided by the display driver library to send and display the second intermediate plane data to the primary plane. Finally, the display controller 205 acquires the first intermediate plane data from the first overlay plane and the second intermediate plane data from the primary plane; then, performs a hardware synthesis on the first intermediate plane data and the second intermediate plane data to obtain the first plane data to be displayed, and display the first plane data to be displayed to obtain the cloud desktop.

Further, in an alternative embodiment, the third initial plane data or the fourth initial plane data may be command streams or regional streams, and for the command streams or the regional streams, the window manager may also provide location information of the first intermediate plane data (or the third initial plane data or the fourth initial plane data) in the cloud desktop. Based on this, the computing processor 201 may also, according to the location information of the first intermediate plane data provided by the window manager in the cloud desktop, call the graphical interface server to send and display the first intermediate plane data to a corresponding location in the first overlay plane. Further, FIG. 3b shows another software framework for cloud desktop display by a terminal device. In this software framework, still taking the interaction between the graphical interface client and the graphical interface server as an example, the processing process of the window menu UI plane data (i.e., the first initial plane data) is the same as that shown in FIG. 3a, so the details are not repeated here. In FIG. 3b, the computing processor 201 also receives the third initial plane data (i.e., video stream data) or the fourth initial plane data (i.e., textual and graphical data) issued by the cloud side server 10, decodes the third initial plane data (i.e., video stream data) or the fourth initial plane data (i.e., textual and graphical data) to obtain the first intermediate plane data, and directly writes the first intermediate plane data into the direct memory access (DMA) cache without GPU rendering. The embodiment shown in FIG. 3b is different from the embodiment shown in FIG. 3a in that, instead of directly calling the display driver interface to send and display the first intermediate plane data to the first overlay plane, the first intermediate plane data is transmitted to the graphical interface server through the interface function in the client interface library, and according to the location information of the first intermediate plane data provided by the window manager (or the third initial plane data or the fourth initial plane data) in the cloud desktop, the graphical interface server sends and displays the first intermediate plane data to the first overlay plane by calling the display driver interface. Finally, the display controller 205 acquires the first intermediate plane data from the first overlay plane and the second intermediate plane data from the primary plane; then, performs a hardware synthesis on the first intermediate plane data and the second intermediate plane data to obtain the first plane data to be displayed, and displays the first plane data to be displayed to obtain the cloud desktop.

Further, in each embodiment of the present disclosure, before the first intermediate plane data is sent and displayed to the first overlay plane, the computing processor 201 is further configured to: according to capability information of the at least one overlay plane, select from the at least one overlay plane an overlay plane simultaneously supporting at least two types of cloud side plane data as the first overlay plane, where the capability information of each overlay plane includes a data format supported by the overlay plane, for example, only supporting a YUV format, only supporting an RGB format, or supporting both the YUV format and the RGB format, etc.

It should be noted that in a practical application, the number of overlay planes and the capability information of the overlay planes contained by different terminal devices are different. Whether the computing processor 201 can select the first overlay plane from the at least one overlay plane depends on the capability information of the overlay plane contained in the terminal device. In some application scenarios, there may be no overlay plane simultaneously supporting at least two types of cloud side plane data among the overlay planes contained in the terminal device, and the computing processor 201 will not be able to select the first overlay plane from them. In view of this situation, in the embodiment, the computing processor 201 is further configured to acquire at least one second overlay plane from the at least one overlay plane in a case that the first overlay plane cannot be selected from the at least one overlay plane, where each second overlay plane supports one type of cloud side plane data. There may be one or more second overlay planes in number, which may be the same as or less than the number of cloud side plane data. When the number of second overlay planes is the same as the number of cloud side plane data, it means that each cloud side plane data can be sent and displayed to an independent second overlay plane. When the number of second overlay planes is less than the number of cloud side plane data, it means that some cloud side plane data cannot be directly sent and displayed to the second overlay plane, and such cloud side plane data needs to be rendered by calling a GPU.

Based on the above description, in the case that the first overlay plane cannot be selected from the at least one overlay plane but at least one second overlay plane is selected, the computing processor 201 judges, upon each reception of target cloud side plane data provided by the cloud side server, whether there is a second overlay plane corresponding to the target cloud side plane data according to a type of the target cloud side plane data. If there is a second overlay plane corresponding to the target cloud side plane data, the target cloud side plane data is decoded to obtain fourth intermediate plane data, and the fourth intermediate plane data is directly sent and displayed to the corresponding second overlay plane without GPU rendering. On the other hand, the computing processor 201 will also load at least one type of local plane data, call a GPU to render the at least one type of local plane data to obtain fifth intermediate plane data, and the fifth intermediate plane data is sent and displayed to the primary plane. Accordingly, the display controller 205 is also configured to acquire the fourth intermediate plane data from the second overlay plane and the fifth intermediate plane data from the primary plane; perform a hardware synthesis according to the fourth intermediate plane data and the fifth intermediate plane data to obtain second plane data to be displayed; and display the second plane data to be displayed to obtain the cloud desktop. It should be noted that in the embodiment, the process of providing the target cloud side plane data to the terminal device by the cloud side server is the same as the previous embodiment, and the process of calling the GPU to render the at least one type of local plane data to obtain the fifth intermediate plane data is the same as the process of obtaining the second intermediate plane data, and details are not described here again.

In a further implementation, if there is no second overlay plane corresponding to the target cloud side plane data, the computing processor is further configured to decode the target cloud side plane data to obtain eighth intermediate plane data; call a GPU to perform a rendering synthesis on the eighth intermediate plane data and the at least one type of local plane data to obtain sixth intermediate plane data; deliver, to the primary plane, the sixth intermediate plane data as the third plane data to be displayed. Accordingly, the displayer is also configured to acquire, from the primary plane, the third plane data to be displayed and display the third plane data to be displayed to obtain the cloud desktop.

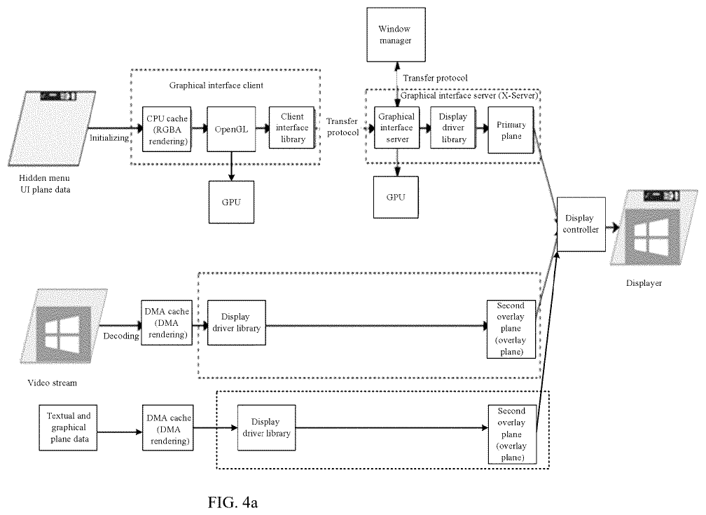

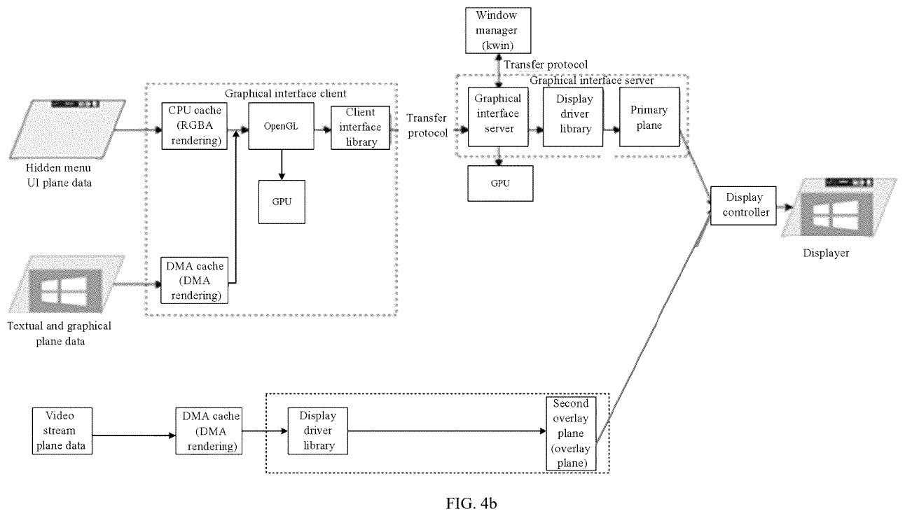

Following the above embodiments, taking the cloud desktop as an example, which includes the first initial plane data (such as hidden menu UI plane data), the third initial plane data (such as Stream plane data) and the fourth initial plane data (such as QXL plane data), FIG. 4a shows a software framework for cloud desktop display by a terminal device. In this software framework, the terminal device includes two second overlay planes and a primary plane, and the two second overlay planes support different data formats. The primary plane corresponds to the first initial plane data (such as hidden menu UI plane data) and is configured to display fifth intermediate plane data obtained by rendering the first initial plane data. One of the second overlay planes corresponds to the third initial plane data, supports the data format of the third initial plane data, and is configured to display fourth intermediate plane data obtained by decoding the third initial plane data (such as Stream plane data). The other one of the second overlay planes corresponds to the fourth initial plane data, supports the data format of the fourth initial plane data, and is configured to display the fourth intermediate plane data obtained by decoding the fourth initial plane data (such as QXL plane data).

Following the above embodiments, taking the cloud desktop as an example, which includes the first initial plane data (such as hidden menu UI plane data), the third initial plane data (such as Stream plane data) and the fourth initial plane data (such as QXL plane data), FIG. 4b shows a further software framework for cloud desktop display by a terminal device, in which the terminal device includes one second overlay plane and a primary plane. The second overlay plane corresponds to the third initial plane data and is configured to display the fourth intermediate plane data obtained by decoding the third initial plane data (such as Stream plane data). The fourth initial plane data needs to be decoded to obtain eighth intermediate plane data, and the GPU is called to perform a rendering synthesis on the eighth intermediate plane data and the first initial plane data to obtain the sixth intermediate plane data. That is, the primary plane corresponds to the first initial plane data and the fourth initial plane data and is configured to display the sixth intermediate plane data obtained by performing a rendering synthesis on the first initial plane data and the fourth initial plane data.

Furthermore, the computing processor is also configured to, in a case that a first overlay plane and any second overlay plane cannot be selected from at least one overlay plane, decode target cloud side plane data to obtain ninth intermediate plane data upon each reception of the target cloud side plane data provided by the cloud side server, call a GPU to perform a rendering synthesis on the ninth intermediate plane data and at least one type of local plane data to obtain seventh intermediate plane data; deliver, to the primary plane, the seventh intermediate plane data as fourth plane data to be displayed, and display the fourth plane data to be displayed to obtain the cloud desktop. In the case that the computing processor loads the local plane data (such as hidden menu UI plane data) and receives the target cloud side plane data (such as Stream plane data /QXL plane data) transmitted by the cloud side server, rendering states of these plane data are initialized, each plane data and its rendering state is packaged, and then the GPU is called for rendering to obtain the seventh intermediate plane data. The seventh intermediate plane data is delivered to the primary plane as the fourth plane data to be displayed, and the fourth plane data to be displayed is displayed to obtain the cloud desktop. It should be noted that in FIG. 4a-FIG. 4b, the architecture of interaction between the graphical interface client and the graphical interface server is still illustrated as an example, and the related implementation logic can be found in the aforementioned embodiments, which is not repeated here.

It should be noted that only some components of the terminal device are shown in FIG. 2. In an implementation, the terminal device may also include other components such as a communication component, a displayer, a power supply component, an audio component, etc.

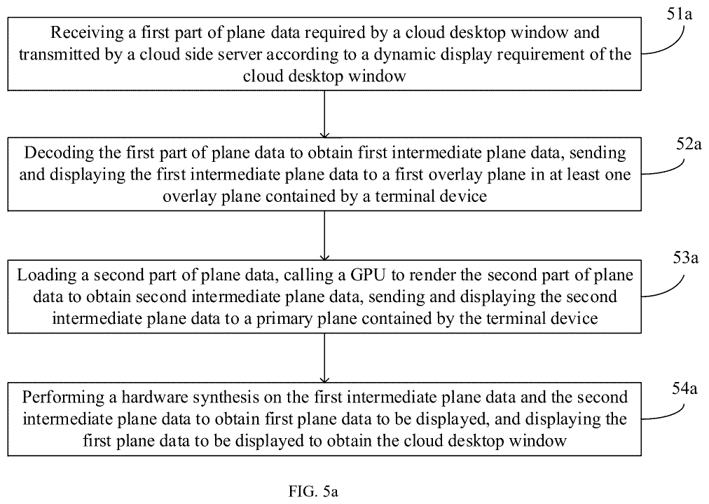

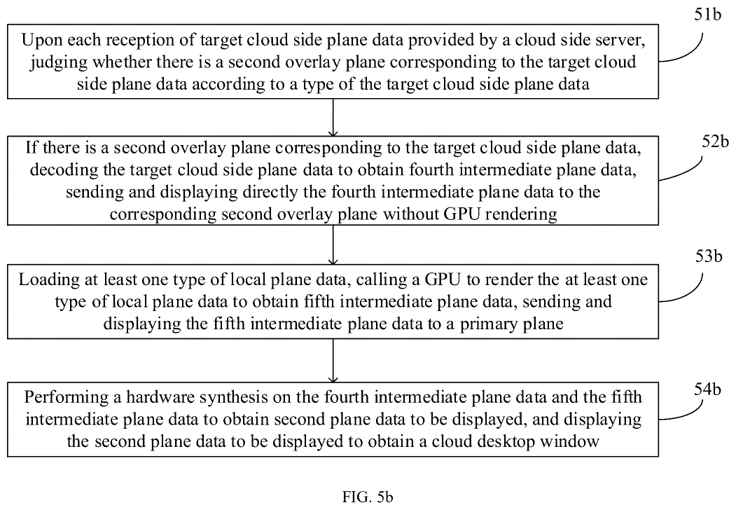

FIG. 5a is a flow diagram of a cloud desktop display method provided by an embodiment of the present disclosure. The method is applied to a terminal device, and the terminal device is configured to provide a second part of plane data required by a cloud desktop and present the cloud desktop. For the implementation structure of the terminal device, please refer to the previous embodiments, and the details are not repeated here. As shown in FIG. 5a, the method includes:
51a. receiving a first part of plane data required by a cloud desktop and transmitted by a cloud side server according to a dynamic display requirement of the cloud desktop;
52a. decoding the first part of plane data to obtain first intermediate plane data, sending and displaying the first intermediate plane data to a first overlay plane in at least one overlay plane contained by a terminal device;
53a. loading a second part of plane data, calling a GPU to render the second part of plane data to obtain second intermediate plane data, sending and displaying the second intermediate plane data to a primary plane contained by the terminal device;
54a. performing a hardware synthesis on the first intermediate plane data and the second intermediate plane data to obtain first plane data to be displayed, and displaying the first plane data to be displayed to obtain the cloud desktop.

In an alternative embodiment, sending and displaying the first intermediate plane data to the first overlay plane in the at least one overlay plane contained by the terminal device includes directly sending and displaying the first intermediate plane data to the first overlay plane without GPU rendering.

In an alternative embodiment, the first part of plane data includes at least two types of cloud side plane data, and the first overlay plane is an overlay plane that simultaneously supports at least two types of cloud side plane data in the at least one overlay plane. Accordingly, receiving the first part of plane data required by the cloud desktop transmitted by the cloud side server according to the dynamic display requirement of the cloud desktop includes: receiving, per time, target cloud side plane data adapted to the dynamic display requirement and transmitted by the cloud side server, where the target cloud side plane data is one of the at least two types of cloud side plane data. Decoding the first part of plane data to obtain the first intermediate plane data includes: decoding the target cloud side plane data to obtain the first intermediate plane data.

In an alternative embodiment, sending and displaying the first intermediate plane data to the first overlay plane in the at least one overlay plane contained by the terminal device includes: writing the first intermediate plane data directly into a DMA cache without GPU rendering, and providing the first intermediate plane data to the first overlay plane through DMA.

In an alternative embodiment, the second part of plane data includes at least one type of local plane data; loading the second part of plane data and calling the GPU to render the second part of plane data to obtain the second intermediate plane data include: simultaneously loading at least one type of local plane data, and calling the GPU to simultaneously render the at least one type of local plane data to obtain the second intermediate plane data.

In an alternative embodiment, the at least one type of local plane data includes first initial plane data, and the first initial plane data refers to window menu content data required by the cloud desktop. Accordingly, calling the GPU to simultaneously render the at least one type of local plane data to obtain the second intermediate plane data includes: initializing a rendering state of the first initial plane data, encapsulating the first initial plane data and the rendering state thereof into a first data packet, and calling the GPU to render the first data packet to obtain third intermediate plane data; calling the GPU to perform a rendering synthesis on second initial plane data provided by a window manager and the third intermediate plane data to obtain the second intermediate plane data, where the second initial plane data refers to window menu style data required by the cloud desktop.

In an alternative embodiment, the at least two types of cloud side plane data include third initial plane data and fourth initial plane data, where the third initial plane data refers to video stream data required by the cloud desktop, and the fourth initial plane data refers to textual and graphical data required by the cloud desktop. Sending and displaying the first intermediate plane data to the first overlay plane in the at least one overlay plane contained by the terminal device includes: calling a graphical interface server to send and display the first intermediate plane data to a corresponding position of the first overlay plane, according to location information of the first intermediate plane data in the cloud desktop provided by the window manager.

In an alternative embodiment, the method of the embodiment further includes: according to capability information of the at least one overlay plane, selecting from the at least one overlay plane an overlay plane simultaneously supporting the at least two types of cloud side plane data as a first overlay plane, where the capability information of the overlay plane includes a data format supported by the overlay plane.

In an alternative embodiment, the method of the embodiment further includes: acquiring at least one second overlay plane from the at least one overlay plane in a case that the first overlay plane cannot be selected from the at least one overlay plane, where each second overlay plane supports one type of cloud side plane data.

Based on the above description, the embodiment of the present disclosure also provides another cloud desktop display method. FIG. 5b is a flow diagram of another cloud desktop display method provided by an embodiment of the present disclosure. The method is applied to a terminal device, and as shown in FIG. 5b, the method includes:
51b. upon each reception of target cloud side plane data provided by a cloud side server, judging whether there is a second overlay plane corresponding to the target cloud side plane data according to a type of the target cloud side plane data;
52b. if there is a second overlay plane corresponding to the target cloud side plane data, decoding the target cloud side plane data to obtain fourth intermediate plane data, sending and displaying directly the fourth intermediate plane data to the corresponding second overlay plane without GPU rendering;
53b. loading at least one type of local plane data, calling a GPU to render the at least one type of local plane data to obtain fifth intermediate plane data, sending and displaying the fifth intermediate plane data to a primary plane;
54b. performing a hardware synthesis on the fourth intermediate plane data and the fifth intermediate plane data to obtain second plane data to be displayed, and displaying the second plane data to be displayed to obtain a cloud desktop.

In a further implementation, the method of the embodiment further includes: if there is no second overlay plane corresponding to the target cloud side plane data, decoding the target cloud side plane data to obtain eighth intermediate plane data; calling a GPU to perform a rendering synthesis on the eighth intermediate plane data and the at least one type of local plane data to obtain sixth intermediate plane data; delivering, to the primary plane, the sixth intermediate plane data as third plane data to be displayed; and displaying the third plane data to be displayed to obtain a cloud desktop.

In a further implementation, the method of the embodiment further includes: in a case that the first overlay plane and any second overlay plane cannot be selected from the at least one overlay plane, upon each reception of the target cloud side plane data provided by the cloud side server, decoding the target cloud side plane data to obtain ninth intermediate plane data; calling a GPU to perform a rendering synthesis on the ninth intermediate plane data and the at least one type of local plane data to obtain seventh intermediate plane data; delivering, to the primary plane, the seventh intermediate plane data as fourth plane data to be displayed, and displaying the fourth plane data to be displayed to obtain a cloud desktop.

It should be noted that the same device can be the execution subject of each step of the method provided in the above embodiments, or different devices act as the execution subject of the method. For example, the execution subject of steps 51a to 51d may be device A; for another example, the execution subject of steps 51a and 51b may be device A, and the execution subject of step 53c may be device B; etc.

In addition, some processes described in the above embodiments and the attached drawings contain a plurality of operations that are shown in a specific order, but it should be clearly understood that these operations may be executed in an order other than that shown herein or may be executed in parallel. The sequence numbers of the operations, such as 51a and 52a, are only used to distinguish different operations, and the sequence numbers themselves do not represent any execution order. In addition, these processes may include more or fewer operations, and these operations may be performed sequentially or in parallel. It should be noted that the descriptions of “first” and “second” herein are used to distinguish different messages, devices, modules, etc., and do not represent a sequential order, nor do they limit that “first” and “second” are different types.

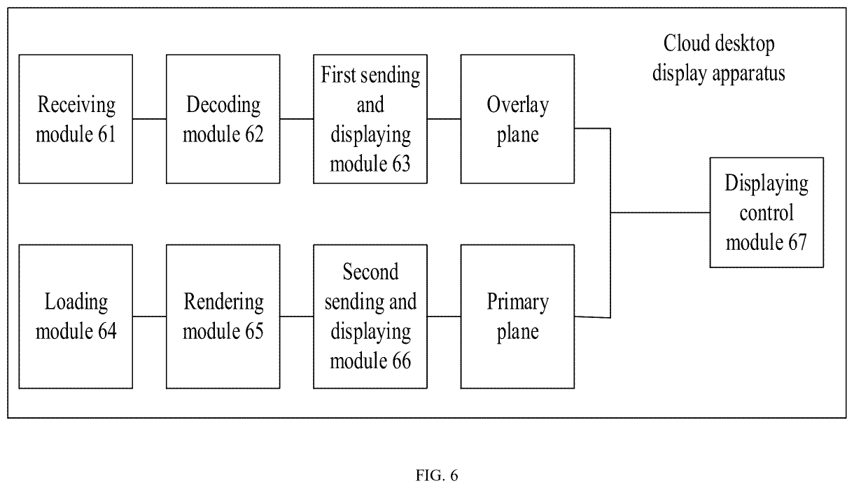

FIG. 6 is a schematic structural diagram of a cloud desktop display apparatus provided by an embodiment of the present disclosure. The apparatus can be applied to a terminal device which is configured to provide a second part of plane data required by a cloud desktop and present the cloud desktop. As shown in FIG. 6, the apparatus includes a receiving module 61, a decoding module 62, a first sending and displaying module 63, a loading module 64, a rendering module 65, a second sending and displaying module 66 and a displaying control module 67.

The receiving module 61 is configured to receive a first part of plane data required by a cloud desktop and transmitted by a cloud side server according to a dynamic display requirement of the cloud desktop.

The decoding module 62 is configured to decode the first part of plane data to obtain first intermediate plane data.

The first sending and displaying module 63 is configured to send and display the first intermediate plane data to a first overlay plane in at least one overlay plane contained by a terminal device.

The loading module 64 is configured to load a second part of plane data.

The rendering module 65 is configured to call a GPU to render the second part of plane data to obtain second intermediate plane data.

The second sending and displaying module 66 is configured to send and display the second intermediate plane data to a primary plane contained by the terminal device.

The displaying control module 67 is configured to perform a hardware synthesis on the first intermediate plane data and the second intermediate plane data to obtain first plane data to be displayed, and displaying the first plane data to be displayed to obtain the cloud desktop.

In an alternative embodiment, the first sending and displaying module 63 is specifically configured to directly send and display the first intermediate plane data to the first overlay plane without GPU rendering.

In an alternative embodiment, the first part of plane data includes at least two types of cloud side plane data, and the first overlay plane is an overlay plane simultaneously supporting at least two types of cloud side plane data in the at least one overlay plane. Accordingly, the receiving module 61 is specifically configured to receive, per time, target cloud side plane data adapted to the dynamic display requirement and transmitted by the cloud side server, where the target cloud side plane data is one of the at least two types of cloud side plane data. Decoding the first part of plane data to obtain the first intermediate plane data includes: decoding the target cloud side plane data to obtain the first intermediate plane data.

In an alternative embodiment, the first sending and displaying module 63 is specifically configured to directly write the first intermediate plane data into a DMA cache without GPU rendering, and provide the first intermediate plane data to the first overlay plane through DMA.

In an alternative embodiment, the second part of plane data includes at least one type of local plane data. The loading module 64 is specifically configured to simultaneously load the at least one type of local plane data, and call a GPU to simultaneously render the at least one type of local plane data to obtain the second intermediate plane data.

In an alternative embodiment, the at least one type of local plane data includes first initial plane data, and the first initial plane data refers to window menu content data required by the cloud desktop. Accordingly, the rendering module 65 is specifically configured to initialize a rendering state of the first initial plane data; encapsulate the first initial plane data and the rendering state thereof into a first data packet; call the GPU to render the first data packet to obtain third intermediate plane data; call the GPU to perform a rendering synthesis on second initial plane data provided by a window manager and the third intermediate plane data to obtain the second intermediate plane data, where the second initial plane data refers to window menu style data required by the cloud desktop.

In an alternative embodiment, the at least two types of cloud side plane data include third initial plane data and fourth initial plane data, where the third initial plane data refers to video stream data required by the cloud desktop, and the fourth initial plane data refers to textual and graphical data required by the cloud desktop. The first sending and displaying module 63 is specifically configured to call a graphical interface server to send and display the first intermediate plane data to a corresponding position of the first overlay plane, according to location information of the first intermediate plane data in the cloud desktop provided by the window manager.

In an optional embodiment, the apparatus of the embodiment further includes a selecting module configured to: according to capability information of the at least one overlay plane, select from the at least one overlay plane an overlay plane simultaneously supporting the at least two types of cloud side plane data as a first overlay plane, where the capability information of the overlay plane includes a data format supported by the overlay plane.

In an alternative embodiment, the selecting module is further configured to acquire at least one second overlay plane from the at least one overlay plane in a case that the first overlay plane cannot be selected from the at least one overlay plane, where each second overlay plane supports one type of cloud side plane data.

Based on the above description, the apparatus of the embodiment further includes a judging module configured to judge, upon each reception of target cloud side plane data provided by the cloud side server, whether there is a second overlay plane corresponding to the target cloud side plane data according to a type of the target cloud side plane data. The decoding module 62 is further configured to decode the target cloud side plane data to obtain fourth intermediate plane data, when the judging module judges that there is a second overlay plane corresponding to the target cloud side plane data. The first sending and displaying module 63 is also configured to directly send and display the fourth intermediate plane data to the corresponding second overlay plane without GPU rendering. Accordingly, the loading module 64 is also configured to load the at least one type of local plane data; the rendering module 65 is also configured to call a GPU to render the at least one type of local plane data to obtain the fifth intermediate plane data; and the second sending and displaying module 66 is also configured to send and display the fifth intermediate plane data to the primary plane. The displaying control module 67 is also configured to perform a hardware synthesis on the fourth intermediate plane data and the fifth intermediate plane data to obtain second plane data to be displayed, and display the second plane data to be displayed to obtain the cloud desktop.

The apparatus provided in the embodiment can be configured to execute steps in the above-mentioned method embodiments. For the detailed functional implementation of each functional module, please refer to the detailed description in the above-mentioned method embodiments or system embodiments, and details will not be repeated here.

Accordingly, an embodiment of the present disclosure also provides a computer-readable storage medium storing a computer program, where the computer program, when executed by a processor, enables the processor to implement steps executable by a terminal device in the above method embodiment.

The communication component in the above embodiments is configured to facilitate wired or wireless communication between a device where the communication component is located and other device(s). The device where the communication component is located can access a wireless network based on a communication standard, such as WiFi, a mobile communication network such as 2G, 3G, 4G/LTE, 5G, or their combination. In an exemplary embodiment, the communication component receives a broadcast signal or broadcast related information from an external broadcast management system via a broadcast channel. In an exemplary embodiment, the communication component further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The displayer in the above embodiments includes a screen which may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense the boundary of a touching or sliding action, but also detect the duration and pressure related to the touching or sliding operation.

The power supply component in the above embodiments provides power for various components of the device where the power supply component is located. The power supply component can include a power management system, one or more power supplies, and other components associated with generation, management and distribution of power for the device where the power supply component is located.

The audio component in the above embodiments can be configured to output and/or input an audio signal. For example, the audio component includes a microphone (MIC), which is configured to receive an external audio signal when the device where the audio component is located is in an operation mode, such as a call mode, a recording mode and a voice recognition mode. The received audio signal may be further stored in a memory or transmitted via a communication component. In some embodiments, the audio component further includes a speaker for outputting an audio signal.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to disk storages, CD-ROMs, optical storages, etc.) containing computer-usable program codes.

The present disclosure is described with reference to a flowchart and/or a block diagram of a method, a device (system), and a computer program product according to an embodiment of the present disclosure. It should be understood that each flow and/or block in the flowchart and/or block diagram, and a combination of the flow and/or block in the flowchart and/or block diagram can be implemented by computer program instructions. These computer program instructions may be provided to a processor of a general-purpose computer, special-purpose computer, embedded processor or other programmable data processing device to produce a machine, such that the instructions which are executed by the processor of the computer or other programmable data processing device produce an apparatus for implementing the function specified in the flow or flows of the flowchart and/or in the block or blocks of the block diagram.

These computer program instructions may also be stored in a computer-readable memory that can direct a computer or other programmable data processing device to function in a particular manner, such that the instructions stored in the computer-readable memory produce an article of manufacture including an instruction apparatus that implements the function specified in the flow or flows of the flowchart and/or in the block or blocks of the block diagram.

These computer program instructions may also be loaded onto a computer or other programmable data processing device, such that a series of operational steps are performed on the computer or other programmable device to produce a computer-implemented process, such that the instructions executed on the computer or other programmable device provide steps for implementing the function specified in the flow or flows of the flowchart and/or in the block or blocks of the block diagram.

In a typical configuration, a computing device includes one or more central processing unit (CPU), input/output interfaces, network interfaces, and memories.

The memory may include a non-permanent memory, a random access memory (RAM) and/or a nonvolatile memory of a computer-readable medium, such as a read-only memory (ROM) or a flash memory (flash RAM). The memory is an example of a computer-readable medium.

The computer-readable medium, including permanent and non-permanent, removable and non-removable media, can store information by any method or technology. The information can be a computer-readable instruction, a data structure, and a module of a program or other data. An example of a computer storage medium includes, but not limited to a phase-change machine (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), and a digital versatile disc (DVD), or other optical storage, a magnetic cassette, a magnetic tape disk storage or other magnetic storage devices or any other non-transmission medium, which can be configured to store information that can be accessed by a computing device. According to the definition herein, a computer-readable medium does not include transitory media (transitory media), such as a modulated data signal and a carrier wave.

It should also be noted that the terms “include”, “contain” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, an element defined by the phrase “including a . . . ” does not exclude the existence of other identical elements in the process, method, commodity or device including the element.

The above description is only an embodiment of the present disclosure, and is not configured to limit the present disclosure. Various modifications and variations of the present disclosure are possible to those skilled in the art. Any modification, equivalent substitution, improvement, etc. made within the spirit and principle of the present disclosure should fall within the scope of the claims of the present disclosure.

1. A cloud desktop system, comprising: a cloud side server configured to provide a first part of plane data required by a cloud desktop, and a terminal device configured to provide a second part of plane data required by the cloud desktop and present the cloud desktop, wherein the terminal device at least comprises a plurality of hardware planes, and the plurality of hardware planes comprise a primary plane and at least one overlay plane;
the cloud side server is configured to transmit the first part of plane data to the terminal device according to a dynamic display requirement of the cloud desktop;
the terminal device is configured to decode the first part of plane data transmitted by the cloud side server to obtain first intermediate plane data, send and display the first intermediate plane data to a first overlay plane in the at least one overlay plane; and
load the second part of plane data, call a graphic processing unit (GPU) to render the second part of plane data to obtain second intermediate plane data, send and display the second intermediate plane data to the primary plane; and
perform a hardware synthesis on the first intermediate plane data and the second intermediate plane data to obtain first plane data to be displayed, and display the first plane data to be displayed to obtain the cloud desktop.

2. A terminal device configured to provide a second part of plane data required by a cloud desktop and present the cloud desktop, wherein the terminal device comprises a computing processor, a memory, a graphic processing unit (GPU), a plurality of hardware planes and a display controller, wherein the plurality of hardware planes comprise a primary plane and at least one overlay plane;
the memory is configured to store a computer program corresponding to a cloud desktop client, and the computing processor is coupled with the memory and configured to execute the computer program, to: receive a first part of plane data required by the cloud desktop and transmitted by a cloud side server according to a dynamic display requirement of the cloud desktop; decode the first part of plane data to obtain first intermediate plane data; send and display the first intermediate plane data to a first overlay plane in the at least one overlay plane; and load the second part of plane data, call the GPU to render the second part of plane data to obtain second intermediate plane data, send and display the second intermediate plane data to the primary plane;
the display controller is configured to perform a hardware synthesis on the first intermediate plane data in the first overlay plane and the second intermediate plane data in the primary plane to obtain first plane data to be displayed, and display the first plane data to be displayed to obtain the cloud desktop.

3. The terminal device according to claim 2, wherein the first part of plane data comprises at least two types of cloud side plane data;
the computing processor is specifically configured to: receive, per time, target cloud side plane data adapted to the dynamic display requirement and transmitted by the cloud side server, wherein the target cloud side plane data is one of the at least two types of cloud side plane data; decode the target cloud side plane data to obtain first intermediate plane data; directly send and display the first intermediate plane data to the first overlay plane without GPU rendering, wherein the first overlay plane is an overlay plane that simultaneously supports the at least two types of cloud side plane data in the at least one overlay plane.

4. A cloud desktop display method applied to a terminal device, wherein the terminal device is configured to provide a second part of plane data required by a cloud desktop and present the cloud desktop, the method comprises:
receiving a first part of plane data required by the cloud desktop and transmitted by a cloud side server according to a dynamic display requirement of the cloud desktop;
decoding the first part of plane data to obtain first intermediate plane data, sending and displaying the first intermediate plane data to a first overlay plane in at least one overlay plane contained in the terminal device;
loading the second part of plane data, calling a GPU to render the second part of plane data to obtain second intermediate plane data, sending and displaying the second intermediate plane data to a primary plane contained in the terminal device;
performing a hardware synthesis on the first intermediate plane data and the second intermediate plane data to obtain first plane data to be displayed, and displaying the first plane data to be displayed to obtain the cloud desktop.

5. The method according to claim 4, wherein sending and displaying the first intermediate plane data to the first overlay plane in the at least one overlay plane contained in the terminal device comprise: directly sending and displaying the first intermediate plane data to the first overlay plane without GPU rendering.

6. The method according to claim 4, wherein the first part of plane data comprises at least two types of cloud side plane data, and the first overlay plane is an overlay plane that simultaneously supports the at least two types of cloud side plane data in the at least one overlay plane;
receiving the first part of plane data required by the cloud desktop and transmitted by the cloud side server according to the dynamic display requirement of the cloud desktop comprises: receiving, per time, target cloud side plane data adapted to the dynamic display requirement and transmitted by the cloud side server, wherein the target cloud side plane data is one of the at least two types of cloud side plane data;
decoding the first part of plane data to obtain the first intermediate plane data comprises decoding the target cloud side plane data to obtain the first intermediate plane data.

7. The method according to claim 6, wherein sending and displaying the first intermediate plane data to the first overlay plane in the at least one overlay plane contained in the terminal device comprises:
directly writing the first intermediate plane data into a direct memory access DMA cache without GPU rendering, and providing the first intermediate plane data to the first overlay plane through DMA.

8. The method according to claim 6, wherein the second part of plane data comprises at least one type of local plane data;
loading the second part of plane data, and calling the GPU to render the second part of plane data to obtain the second intermediate plane data comprise: simultaneously loading the at least one type of local plane data, and calling the GPU to simultaneously render the at least one type of local plane data to obtain the second intermediate plane data.

9. The method according to claim 8, wherein the at least one type of local plane data comprises first initial plane data, and the first initial plane data refers to window menu content data required by the cloud desktop;
calling the GPU to simultaneously render the at least one type of local plane data to obtain the second intermediate plane data comprises:
initializing a rendering state of the first initial plane data, encapsulating the first initial plane data and the rendering state thereof into a first data packet, and calling the GPU to render the first data packet to obtain third intermediate plane data;
calling the GPU to perform a rendering synthesis on second initial plane data provided by a window manager and the third intermediate plane data to obtain the second intermediate plane data, wherein the second initial plane data refers to window menu style data required by the cloud desktop.

10. The method according to claim 9, wherein the at least two types of cloud side plane data comprise third initial plane data and fourth initial plane data, wherein the third initial plane data refers to video stream data required by the cloud desktop, and the fourth initial plane data refers to textual and graphical data required by the cloud desktop;
sending and displaying the first intermediate plane data to the first overlay plane in the at least one overlay plane contained in the terminal device comprise:
according to location information of the first intermediate plane data in the cloud desktop provided by the window manager, calling a graphical interface server to send and display the first intermediate plane data to a corresponding position in the first overlay plane.

11. The method according to claim 8, further comprising:
according to capability information of the at least one overlay plane, selecting from the at least one overlay plane an overlay plane simultaneously supporting the at least two types of cloud side plane data as a first overlay plane, wherein the capability information of the overlay plane comprises a data format supported by the overlay plane.

12. The method according to claim 11, further comprising:
in a case that it is unlikely to select the first overlay plane from the at least one overlay plane, acquiring at least one second overlay plane from the at least one overlay plane, wherein each second overlay plane supports one type of cloud side plane data; and
upon each reception of target cloud side plane data provided by the cloud side server, judging whether there is a second overlay plane corresponding to the target cloud side plane data according to a type of the target cloud side plane data;
if there is a second overlay plane corresponding to the target cloud side plane data, decoding the target cloud side plane data to obtain fourth intermediate plane data, sending and displaying the fourth intermediate plane data to the corresponding second overlay plane;
calling the GPU to render the at least one type of local plane data to obtain fifth intermediate plane data, sending and displaying the fifth intermediate plane data to the primary plane;
performing a hardware synthesis on the fourth intermediate plane data and the fifth intermediate plane data to obtain second plane data to be displayed, and displaying the second plane data to be displayed to obtain the cloud desktop.

13. The method according to claim 12, further comprising:
if there is no second overlay plane corresponding to the target cloud side plane data, decoding the target cloud side plane data to obtain eighth intermediate plane data, and calling the GPU to perform a rendering synthesis on the eighth intermediate plane data and the at least one type of local plane data to obtain sixth intermediate plane data;
delivering, to the primary plane, the sixth intermediate plane data as third plane data to be displayed; displaying the third plane data to be displayed to obtain the cloud desktop.

14. A non-transitory computer-readable storage medium storing a computer program, wherein when the computer program is executed by a processor, the processor is enabled to implement steps in the method according to claim 4.

15. The method according to claim 9, further comprising:
according to capability information of the at least one overlay plane, selecting from the at least one overlay plane an overlay plane simultaneously supporting the at least two types of cloud side plane data as a first overlay plane, wherein the capability information of the overlay plane comprises a data format supported by the overlay plane.

16. The method according to claim 10, further comprising:
according to capability information of the at least one overlay plane, selecting from the at least one overlay plane an overlay plane simultaneously supporting the at least two types of cloud side plane data as a first overlay plane, wherein the capability information of the overlay plane comprises a data format supported by the overlay plane.

17. The method according to claim 15, further comprising:
in a case that it is unlikely to select the first overlay plane from the at least one overlay plane, acquiring at least one second overlay plane from the at least one overlay plane, wherein each second overlay plane supports one type of cloud side plane data; and
upon each reception of target cloud side plane data provided by the cloud side server, judging whether there is a second overlay plane corresponding to the target cloud side plane data according to a type of the target cloud side plane data;
if there is a second overlay plane corresponding to the target cloud side plane data, decoding the target cloud side plane data to obtain fourth intermediate plane data, sending and displaying the fourth intermediate plane data to the corresponding second overlay plane;
calling the GPU to render the at least one type of local plane data to obtain fifth intermediate plane data, sending and displaying the fifth intermediate plane data to the primary plane;
performing a hardware synthesis on the fourth intermediate plane data and the fifth intermediate plane data to obtain second plane data to be displayed, and displaying the second plane data to be displayed to obtain the cloud desktop.

18. The method according to claim 16, further comprising:
in a case that it is unlikely to select the first overlay plane from the at least one overlay plane, acquiring at least one second overlay plane from the at least one overlay plane, wherein each second overlay plane supports one type of cloud side plane data; and
upon each reception of target cloud side plane data provided by the cloud side server, judging whether there is a second overlay plane corresponding to the target cloud side plane data according to a type of the target cloud side plane data;
if there is a second overlay plane corresponding to the target cloud side plane data, decoding the target cloud side plane data to obtain fourth intermediate plane data, sending and displaying the fourth intermediate plane data to the corresponding second overlay plane;
calling the GPU to render the at least one type of local plane data to obtain fifth intermediate plane data, sending and displaying the fifth intermediate plane data to the primary plane;
performing a hardware synthesis on the fourth intermediate plane data and the fifth intermediate plane data to obtain second plane data to be displayed, and displaying the second plane data to be displayed to obtain the cloud desktop.

19. The method according to claim 17, further comprising:
if there is no second overlay plane corresponding to the target cloud side plane data, decoding the target cloud side plane data to obtain eighth intermediate plane data, and calling the GPU to perform a rendering synthesis on the eighth intermediate plane data and the at least one type of local plane data to obtain sixth intermediate plane data;
delivering, to the primary plane, the sixth intermediate plane data as third plane data to be displayed; displaying the third plane data to be displayed to obtain the cloud desktop.

20. The non-transitory computer-readable storage medium according to claim 14, the processor is further enabled to directly send and display the first intermediate plane data to the first overlay plane without GPU rendering.
